(19) United States
(12) Patent Application Publication
(10) Pub. No.: US 2015/0082192 A1
(43) Pub. Date: Mar. 19, 2015

(54) Highlighted Display of Unopened (Unread) Email Approaching Expiration Date

(71) Applicant: International Business Machines Corporation, Armonk, NY (US)

(72) Inventor: Kazuhiro Tsuruta, Tokyo (JP)

(21) Appl. No.: 14/450,646

(22) Filed: Aug. 4, 2014

(30) Foreign Application Priority Data
Sep. 13, 2013 (JP) 2013-190458

(51) Int. Cl. G06F 17/30; G06F 17/24; H04L 12/58

(52) U.S. Cl. CPC G06F 17/30716; H04L 51/22; G06F 17/24
USPC 715/752

(57) ABSTRACT

A mechanism is provided for highlighting a display related to unopened (unread) delivered email. The mechanism determines whether a delivered email has been opened (read) or remains unopened (unread). When it has been determined that the delivered email remains unopened, the mechanism determines whether the expiration date established for the delivered email has passed. When it has been determined that the established expiration date has not passed, the mechanism determines whether the time threshold for starting highlighted display established for the delivered email has passed. When it has been determined that the time threshold has passed, the mechanism highlights the display related to the delivered email.

### BACKGROUND

The present invention relates to a computer processing technique for applying attributes to and selectively highlighting the display of email.

In the delivery of email, email with the same content can be simultaneously sent to multiple recipients. Email is widely used as a means of promoting sales and attracting customers by following existing customers, gaining potential customers, and as a simple means of providing information, such as encouraging participation in meetings and providing event notes. While delivered email can be beneficial to users receiving the email, it is often deleted unread or left unread because some email has a malicious intent, such as unsolicited bulk email (spam), while others contains advertising that does not interest the user.

With the exception of unsolicited bulk email, the content of delivered. email often contains expiration dates which may or may not be explicitly established or stated, For example, the content of an advertising email may have a campaign expiration date one week after delivery, or the content of an email announcing an event may become irrelevant once the date of that event passes. Thus, the effect of delivering email fades from the standpoint of the sender of the email (the deliverer of the email) when the email is deleted unopened or remains unopened after the expiration date has passed.

Techniques have been disclosed in Patent Literature, such as JP Patent Publication No. 2009-.017579, JP Patent Publication No. 2004.-170636, JP Patent Publication No. 2002-149747, and JP Patent Publication No. 2001-282651, in which delivered email is automatically deleted when an expiration date has been reached,

### SUMMARY

It is an object of the present invention to provide a method and system for email delivery which encourages recipients to open email by establishing an expiration date for delivered email and highlighting the display of the subject header of unread email approaching its expiration date.

In one illustrative embodiment, a method, in a data processing system, is provided for highlighting a display related to unopened (unread) delivered email. The illustrative embodiment determines whether a delivered email has been opened (read) or remains unopened (unread). The illustrative embodiment determines whether an established expiration date of the delivered email has passed when the delivered email remains unopened. The illustrative embodiment determines whether a time threshold for starting a highlighted display established for the delivered email has passed when the established expiration date has not passed. The illustrative embodiment highlights the display related to the delivered email when the time threshold has passed.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment,

In yet another illustrative embodiment, a system apparatus is provided. The system/apparatus may comprise one or more processors and a memory coupled to the one or more processors. The memory may comprise instructions which, when executed by the one or more processors, cause the one or more processors to perform various ones of, and combinations of the operations outlined above with regard to the method illustrative enibodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

FIG. 1 shows the process of the present invention by which the sender of an email establishes in advance an expiration date and a highlighting method for unread email;

FIG. 2 shows the process of the present invention by which the subject header of an email approaching its deadline is highlighted and displayed for a predetermined amount of time in order to alert the recipient by displaying the email prior to the display of the list of email in the recipient's inbox (received email management site) when the sender has established an expiration date for the email and the email software of the recipient has been launched;

FIG. 3 shows a list of email displayed in the inbox of the email software launched by the recipient of the email according to an example of the present invention;

FIG. 4 shows an example of a received email management table needed to realize the present invention; and

FIG. 5 shows an example of a system configuration used to realize the present invention.

### DETAILED DESCRIPTION

As stated above, the content of delivered email often contains expiration dates which may or may not be explicitly established or stated. Thus, the effect of delivering email fades from the standpoint of the sender of the email (the deliverer of the email) when the email is deleted unopened or remains unopened after the expiration date has passed. Therefore, the illustrative embodiments allows a sender to establish an expiration date for unread email beforehand and for highlighting the subject header of the email on the recipient's end in response to the expiration date. Accordingly, delivered email is displayed so as to be highlighted relative to other listed email messages displayed prior to the expiration date of the delivered email. In this way, a sender of email (deliverer of email) can expect the recipient to be more likely to open the email when compared to use of the prior art.

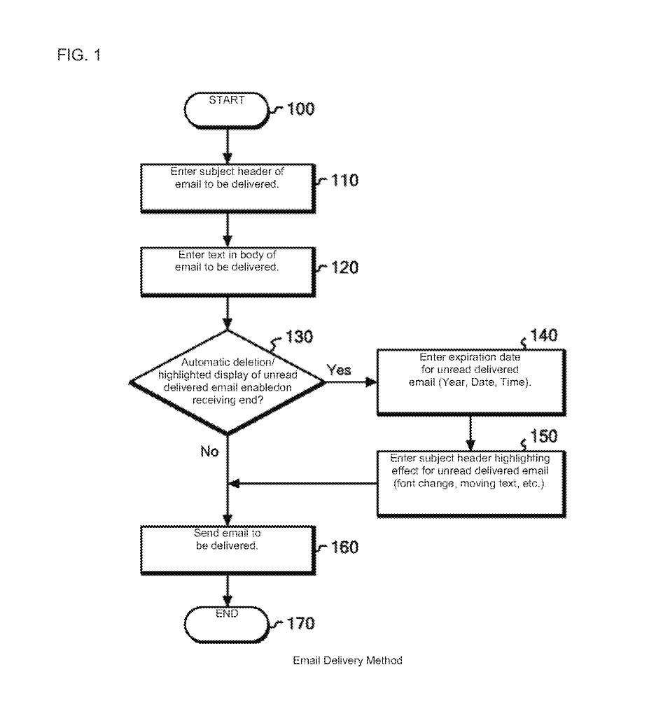

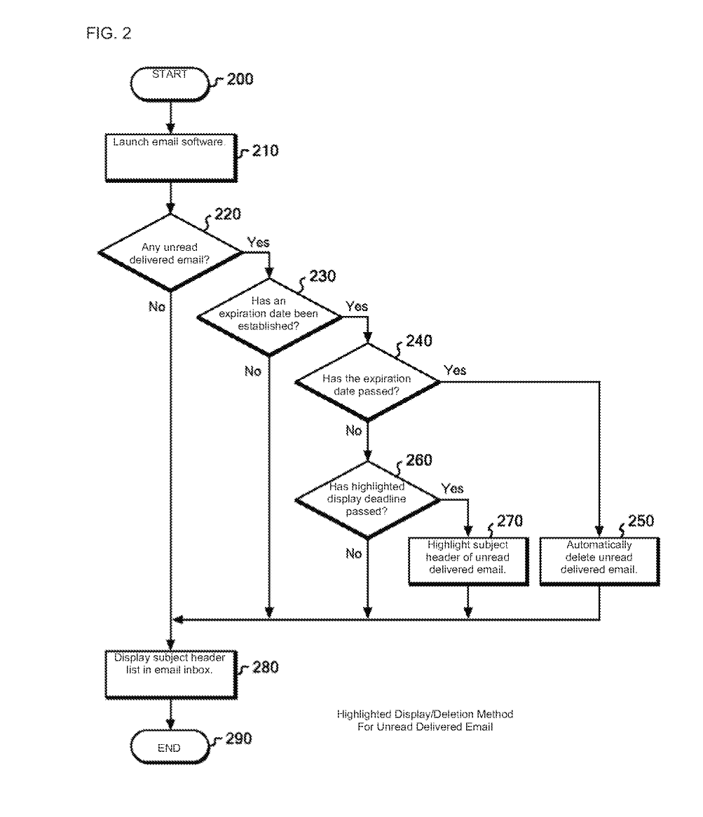

The present invention is configured using an email delivery system (FIG. 1) and an email receiving system (FIG. 2) having the following functions,

FIG. 1 shows the process 100 of the present invention in which the sender of an email establishes in advance an expiration date and a highlighting method for unread email. In Step 110, a subject header is entered in the email to be delivered. In Step 120, text is entered in the body of the email to be delivered. In Step 130, it is determined whether or not the automatic deletion or highlighting of unopened (unread) delivered email is enabled on the receiving end. The determination in Step 130 may be performed optionally by the sender.

When it has been determined in Step 130 that the automatic deletion or highlighting of unopened (unread) delivered email is enabled on the receiving end (Yes), then in Step 140, an expiration date is established as an attribute of the delivered email related to enabling the receiving end to determine whether or not the delivered email has been opened so that the display related to the unopened (unread) email can be highlighted on the receiving end. Whether or not the expiration date has passed can be determined on the receiving end. The year, date and time may be optionally established in accordance with the intended purpose of the delivered email.

In Step 150, a time threshold for starting highlighted display may be established as an attribute of the delivered email related to enabling the receiving end to determine whether or not the expiration date has passed. The sender can establish an effective deadline for beginning the highlighted display in relation to the significance of the expiration date. In order to effectively encourage the recipient to open the delivered email, a font change or moving text may be selected as highlighted display options.

When it has been determined in Step 130 that the automatic deletion or highlighting of unopened (unread) delivered email fails to be enabled on the receiving end (No) or from Step 150, then in Step 160, the email to be delivered is sent by the sender, with the process ending in Step 170.

FIG. 2 shows the process 200 of the present invention by which the subject header of an email approaching its deadline is highlighted and displayed for a predetermined amount of time in order to alert the recipient by displaying the email prior to the display of the list of email in the recipient's inbox (received email management site) when the sender has established an expiration date for the email and the email software of the recipient has been launched.

In Step 210, email software is launched in order to highlight the display related to unopened (unread) email. In Step 220, it is determined whether the delivered email has been opened (read) or remains unopened (unread). When it has been determined in Step 220 that the delivered email remains unopened (Yes), it is determined in Step 230 whether or not an expiration date has been established for the delivered email. When it has been determined in Step 230 that an expiration date has been established (Yes), it is determined in Step 240 whether or not the expiration date of the delivered email has passed.

When it has been determined in Step 240 that an expiration date has not passed (No), it is determined in Step 260 whether or not the time threshold established for the delivered email for starting highlighted display has passed. When it has been determined in Step 260 that the time threshold has passed (Yes), the display related to the unopened (unread) email is highlighted in Step 270. For example, the subject header of the delivered email is highlighted. When it has been determined in Step 240 that the established expiration date has passed (Yes), the delivered email may be automatically deleted in Step 250 without forcing the recipient to delete the unread email.

When it has been determined in Step 220 that the delivered email has been opened (read) before the expiration date (No), when it has been determined in Step 230 that an expiration date has not been established (No), when it has been determined in Step 260 that the time threshold has not passed (No), from Step 270, or from step 250, the delivered email is displayed in the recipient's inbox in Step 280 in the same manner as other email, with the process ending in Step 290.

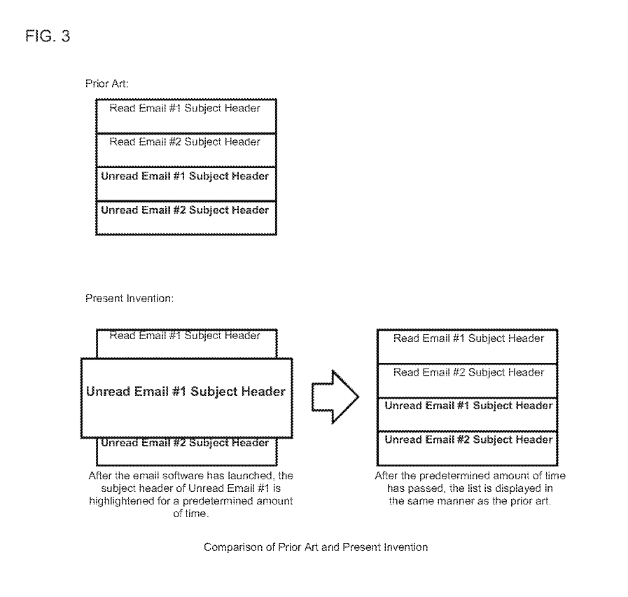

FIG. 3 shows a list of email displayed in the inbox of the email software launched by the recipient of the email according to an example of the present invention. The techniques used to display an email inbox on a computer display (such as a PC display) and list email messages by subject header are well known in the prior art. For a predetermined amount of time (for example, 5 seconds), the subject header of Unread Email #1, whose highlighting deadline has passed, is highlighted relative to the subject headers of the other email messages. After the predetermined amount of time has passed, the subject header may be displayed on the list in the same manner as in the prior art. The font may be changed or the text may move as a highlighting option in relation to the setting established in Step 150 (FIG. 1).

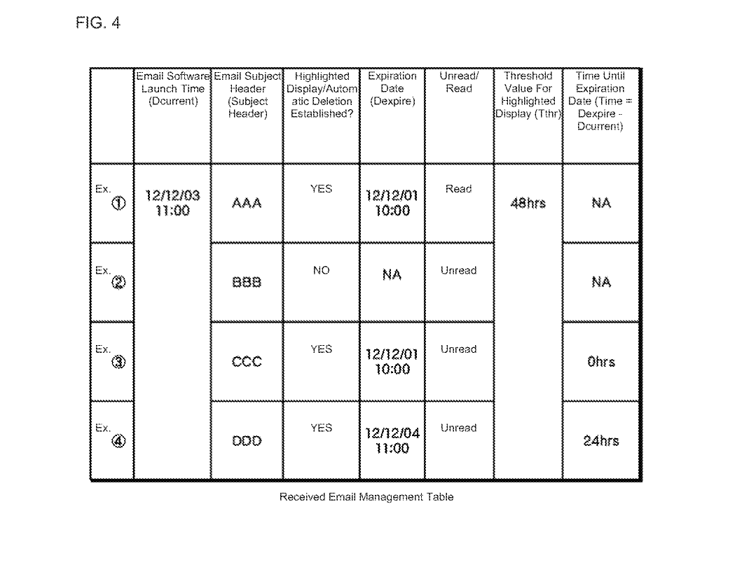

FIG. 4 shows an example of a received email management table needed to realize the present invention. This management table is managed on the receiving end, and the attributes of the email delivered by (received from) the sender are stored in the computer so that the display related to unopened (unread) email can be highlighted. The expiration date is stored as an attribute of the delivered email related to enabling the receiving end to determine whether or not the delivered email has been opened. The time threshold for starting highlighted display is stored as an attribute of the delivered email related to enabling the receiving end to determine whether or not the expiration date has passed. The expiration date and time threshold for starting highlighted display may be combined as attributes of delivered email and stored whether or not the email is read or unread. The time threshold for starting highlighted display may be calculated from the expiration date and stored. The (remaining) time until the expiration date may also be calculated from the expiration date and the time threshold for starting highlighted display and stored.

In FIG. 4, the expiration date is stored in a column (or row) as an attribute of delivered email, the time threshold for starting highlighted display is stored in a column (or row) as an attribute of delivered email, and these are stored in a plurality of rows (or columns) for each delivered email. As shown in FIG. 4, each row indicates whether or not the subject header of the email message is to be highlighted in the email list of the email software and automatically deleted from the email inbox. Ex. (1) (1st Line): Highlighted displayautomatic deletion has been selected, and the email software launch time Dcurrent has passed the expiration date Dexpire. However, the email is not highlighted or automatically deleted because the email has already been read. Ex. (2) (2nd Line): The email is not highlightedautomatically deleted because highlighted dispilaylautomatic deletion has not been selected. Ex. (3) (3rd Line): Highlighted displayautomatic deletion has been selected, and the email software launch time Dcurrent is passed the expiration date Dexpire. Therefore, the email is deleted from the email inbox because it is still unread. Ex. (4) (4th Line): Highlighted displayautomatic deletion has been selected, the email is below the threshold value for highlighted display, and the display of the email is highlighted because it is still unread. When there are several email messages meeting highlighted display conditions, the email messages may be listed in order by expiration date as well as message size.

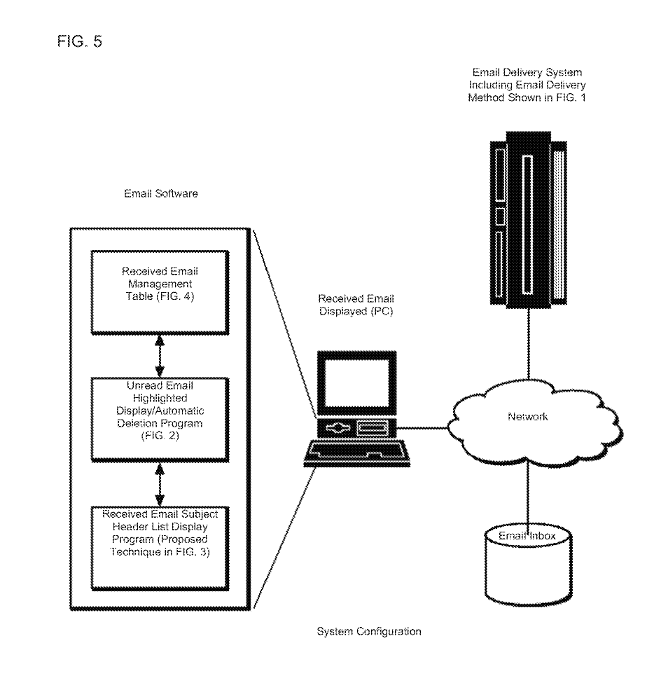

FIG. 5 shows an example of a system configuration used to realize the present invention. The email delivery system used to realize the email delivery method shown in FIG. 1 is connected via a network to a PC which displays an email inbox for managing received email and which lists the subject headers of received email. The email software is executed by the PC on which the received email is displayed. The present invention can be realized as email software embodying each step in the method. The management table can also be stored as email software.

1. A method, in a data processing system, highlighting a display related to unopened (unread) delivered email, the method comprising:
determining, by a processor in the data processing system, whether a delivered email has been opened (read) or remains unopened (unread);
determining, by the processor, whether an expiration date established for the delivered email has passed when the delivered email remains unopened;
determining, by the processor, whether a time threshold for starting a highlighted display established for the delivered email has passed when the established expiration date has not passed; and
highlighting, by the processor, the display related to the delivered email when the time threshold has passed.

2. The method according to claim 1, further comprising:
deleting, by the processor, an unopened delivered email message when the established expiration date has passed.

3. The method according to claim 1, wherein the highlighting of the display related to the delivered email is executed in the list of received email.

4. The method according to claim 3, wherein the highlighted display is ended after the highlighted display has been performed for a predetermined amount of time.

5. The method according to claim 1, wherein the time threshold for starting the highlighted display is calculated from the established expiration date.

6. The method according claim 1, wherein the highlighting of the display related to the delivered email is based on a sender establishing attributes for the delivered email so as to enable highlighted display related to the unopened (unread) delivered email on a receiving end, the method further comprising:
establishing, by the processor, as an attribute of delivered email, an expiration date related to enabling the receiving end to determine whether or not the delivered email has been opened; and
establishing, by the processor, as an attribute of delivered email, a time threshold for starting highlighted display related to enabling the receiving end to determine whether or not the established expiration date has passed.

7. (canceled)

8. The method according to claim 6, further comprising:
generating, by the processor, a management table on the receiving end for storing the attributes for the delivered email (received email) from a sender in a computer so as to enable highlighted display related to the unopened (unread) delivered email;
storing, by the processor, as an attribute of delivered email, the expiration date related to enabling the receiving end to determine whether or not the delivered email has been opened; and
storing, by the processor, as an attribute of delivered email, the time threshold for starting highlighted display related to enabling the receiving end to determine whether or not the expiration date has passed.

9. The method according to claim 8, wherein the expiration date and time threshold for starting highlighted display are combined and stored as attributes of the delivered email regardless of whether the delivered email is read or unread.

10-12. (canceled)

13. A system for highlighting a display related to unopened (unread) delivered email, the system comprising:
a processor; and
a memory coupled to the processor wherein the memory comprises instructions which, when executed by the processor, cause the processor to:
determine whether a delivered email has been opened (read) or remains unopened (unread);
determine whether an expiration date established for the delivered email has passed when the delivered email remains unopened;
determine whether a time threshold for starting highlighted display established for the delivered email has passed when the established expiration date has not passed; and
highlight the display related to the delivered email when the time threshold has passed.

14. The system according to claim 13, wherein the highlighting, of the display related to the delivered email is based on a sender establishing attributes for the delivered email so as to enable highlighted display related to the unopened (unread) delivered email on a receiving end, the instructions further causing the processor to:
establish, as an attribute of delivered email, the expiration date related to enabling the receiving end to determine whether or not the delivered email has been opened; and
establish, as an attribute of delivered email, the time threshold for starting highlighted display related to enabling the receiving end to determine whether or not the established expiration date has passed.

15. (canceled)

16. The system according to claim 14, wherein the instructions further cause the processor to:
generate a management table on the receiving end for storing the attributes for the delivered email (received email) from a sender in a computer so as to enable highlighted display related to the unopened (unread) delivered email;
store, as an attribute of delivered email, the expiration date related to enabling the receiving end to determine whether or not the delivered email has been opened; and
store, as an attribute of delivered email, the time threshold for starting highlighted display related to enabling the receiving end to determine whether or not the expiration date has passed.

17. The system according to claim 16, wherein the expiration date and time threshold for starting highlighted display are combined and stored as attributes of the delivered email regardless of whether the delivered email is read or unread.

18. The system according to claim 13, wherein the highlighting of the display related to the delivered email is executed in the list of received email and wherein the highlighted display is ended after the highlighted display has been performed for a predetermined amount of time.

19. The system according to claim 13, wherein the time threshold for starting the highlighted display is calculated from the established expiration date.

20. A computer program product comprising a computer readable storage medium having a computer readable program stored therein, wherein the computer readable program, when executed on a computing device, causes the computing device to:
determine whether a delivered email has been opened (read) or remains unopened (unread);
determine whether an expiration date established for the delivered email has passed when the delivered email remains unopened;
determine whether a time threshold for starting highlighted display established for the delivered email has passed when the established expiration date has not passed; and
highlight the display related to the delivered email when the time threshold has passed.

21. The computer program product according to claim 20, wherein the highlighting of the display related to the delivered email is executed in the list of received email and wherein the highlighted display is ended after the highlighted display has been performed for a predetermined amount of time.

22. The computer program product according to claim 20, wherein the time threshold for starting the highlighted display is calculated from the established expiration date.

23. The computer program product according to claim 20, wherein the highlighting of the display related to the delivered email is based on a sender establishing attributes for the delivered email so as to enable highlighted display related to the unopened (unread) delivered email on a receiving end, the computer readable program further causing the computing device to:
establish, as an attribute of delivered email, the expiration date related to enabling the receiving end to determine whether or not the delivered email has been opened; and
establish, as an attribute of delivered email, the time threshold for starting highlighted display related to enabling the receiving end to determine whether or not the established expiration date has passed.

24. The computer program product according to claim 23, wherein the computer readable program further causes the computing device to:
generate a management table on the receiving end for storing the attributes for the delivered email (received email) from a sender in a computer so as to enable highlighted display related to the unopened (unread) delivered email;
store, as an attribute of delivered email, the expiration date related to enabling the receiving end to determine whether or not the delivered email has been opened; and
store, as an attribute of delivered email, the time threshold for starting highlighted display related to enabling the receiving end to determine whether or not the expiration date has passed.

25. The computer program product according to claim 24, wherein the expiration date and time threshold for starting highlighted display are combined and stored as attributes of the delivered email regardless of whether the delivered email is read or unread.
